(19) United States
(12) Patent Application Publication
(10) Pub. No.: US 2003/0113244 A1
(43) Pub. Date: Jun. 19, 2003

(54) Method for producing carbon monoxide by reverse conversion with an adapted catalyst

(76) Inventors: Rene Dupont, Douai (FR); Pierre Gauthier, Fresnes (FR); Pascal Marty, Paris (FR)

Correspondence Address: Air Liquide, Intellectual Property Department, Suite 1800, 2700 Post Oak Boulevard, Houston, TX, 77056, US

(21) Appl. No.: 10/220,873

(22) PCT Filed: Mar. 7, 2001
(86) PCT No.: PCT/FR01/00689

(30) Foreign Application Priority Data
Mar. 7, 2000 (FR) 00 02927

(51) Int. Cl. C01B 31/18; B01J 8/02

(52) U.S. Cl. 422/211; 423/418.2; 422/198; 422/199; 422/200; 422/202

(57) ABSTRACT

The invention concerns a method for producing carbon monoxide by reverse conversion, in gas phase, of carbonic acid gas and gaseous hydrogen while minimising the production of methane. The invention is characterised in that the reaction is carried out at a temperature between 300 and 520° C. and under pressure between 10 to 40 bars in the presence of an iron-free catalyst based on zinc oxide and chromium oxide. Said method is preferably carried out continuously and comprises preferably the following steps which consist in: a) preparing a gas mixture rich in carbon dioxide and in hydrogen having a temperature between 300 and 520° C.: b) reacting said gas mixture, forming carbon monoxide and water vapour, by passing said mixture through a catalytic bed based on zinc oxide and chromium oxide maintained under pressure between 10 and 40 bars; c) cooling the gas flux derived from the catalytic bed so as to cause condensation of all or part of the water vapour formed; d) separating the condensed water from said gas fluid; e) optionally, re-treating at least once the resulting gas stream. previously brought to a temperature between 300 and 520° C., by performing steps b) to d) above, so as to increase the proportion of carbon monoxide in the gas stream, each step b) being carried out in a different catalytic bed.

The invention relates to a process for the production of carbon monoxide by reverse conversion, in the gas phase, of hydrogen and carbon dioxide.

The reaction of hydrogen with carbon dioxide results, under appropriate operating conditions, in a mixture of water and carbon monoxide. This reaction leads to an equilibrium between the various constituents and metal catalysts are generally used to approach this equilibrium in times compatible with an acceptable size of the reactors. To shift the equilibrium towards the formation of carbon monoxide, it is known to operate in the presence of metal catalysts.

Thus, EP 737 647 and EP 742 172 propose the use of catalysts based on copper-zinc oxide or catalysts based on iron-chromium. These catalysts are not optimum insofar as their lifetime is very limited under the operating conditions facilitating the reverse conversion of hydrogen with carbon dioxide, which conditions involve in particular high temperatures and a low partial pressure of water.

EP 737 647 and EP 742 172 illustrate more particularly the use of a process for the production of carbon monoxide, comprising the steps consisting in:

a—producing a gas mixture consisting of CO, CO₂ and hydrogen by gaseous steam/methane catalytic reforming;

b—treating the gas mixture, after removing the water at room temperature, in a reactor containing both (i) a catalyst allowing the CO₂ to be converted into CO by reaction of the latter with hydrogen and (ii) an absorbent allowing in situ removal of the water formed.

More specifically, the water is removed by absorption on an absorbent which may be silica, alumina or a zeolite.

The use of such an absorbent for trapping water requires a cyclic operation of the reactor with absorption, depressurization, regeneration and repressurization phases.

To obtain continuous production, at least two reactors are needed, and recycling means are needed to improve the efficiency of the process.

The invention aims to solve all of the drawbacks of the prior art by providing a process using a catalyst suitable for the production of carbon monoxide at high temperature and at low partial pressure of water, and in which the removal of the water does not involve a cyclic absorption and regeneration process.

The invention relates in general to a process for the production of carbon monoxide by reverse conversion in the gas phase of CO₂ and H₂, characterized in that the reaction is carried out in the presence of a catalyst based on zinc oxide and chromium oxide, and not containing iron.

The simultaneous presence of zinc oxide (ZnO) and chromium oxide (Cr₂O₃) in the catalyst is, according to the invention, essential for obtaining a good reaction rate for the conversion of CO₂ into CO.

The presence of iron in the catalyst must be avoided, this metal element favoring the side reactions of methane and methanol production.

Moreover, the catalyst preferably includes only a small amount of nickel. Thus, the catalyst will generally include no more than 2.5% by weight, preferably no more than 1.5% by weight and better still no more than 0.5% by weight of nickel.

Preferably, the catalyst of the invention includes only traces of nickel and better still no nickel at all. This is because the presence of nickel favors the methanation side reaction with the undesirable formation of methane.

In a second method of implementing the invention, the weight ratio of zinc oxide to chromium oxide is between 1.5 and 4.5, advantageously between 1.5 and 2.5, for example between 1.7 and 2.2.

As an example, the catalyst that can be used according to the invention comprises 50 to 90%, preferably 55 to 85% and better still 60 to 68% by weight of zinc oxide and 15 to 45%, preferably 20 to 40% and better still 30 to 36% by weight of chromium oxide, the percentages by weight being calculated in relation to the total amount of active substances present in the catalyst.

The active substances of the catalyst are the metal oxides and more generally the metal compounds present in the catalyst.

Catalysts meeting these characteristics can be easily prepared by a person skilled in the art by using conventional methods.

According to the invention, the catalyst may be used as it is or impregnated on an inert support. Advantageously, the catalyst is used as it is, in the form of granules or pellets, the equivalent diameter of which generally varies between 1 and 20 mm, preferably between 5 and 10 mm.

The equivalent diameter is the diameter of the sphere having the same surface area as the catalyst pellet or granule.

The reaction of hydrogen with carbon dioxide is generally carried out by making a gas mixture containing said reactants, come into contact with the catalyst at a temperature of 300 to 520° C., preferably 300 to 500° C. and better still 300 to 450° C. It should be noted that the higher the reaction temperature, the higher the degree of conversion of carbon dioxide into carbon monoxide. However, too high a temperature is undesirable insofar as it runs the risk of favoring side reactions and causing the degradation of the catalyst.

The gas mixture treated according to the process of the invention is a gas mixture rich in carbon dioxide and in hydrogen. The presence of other gases in this mixture is not excluded provided that these do not interfere with the reaction, or only very slightly. Thus, the initial gas mixture may contain steam or methane.

The expression “rich in carbon dioxide and in hydrogen” is understood to mean, according to the invention, a gas mixture in which the hydrogen and the carbon dioxide constitute a fraction of the gas mixture of at least 50% by volume, preferably at least 70% by volume and better still at least 90% by volume.

According to one particularly preferred method of implementing the invention, the gas mixture essentially consists of gaseous carbon dioxide and gaseous hydrogen.

Advantageously, the process of the invention is carried out on the site of a production unit discharging carbon dioxide as waste gas, for example on the site of an ammonia production unit. The gaseous hydrogen is conveyed to the site by a pipeline.

According to another method of implementing the invention, the gas mixture comes from a hydrocarbon reforming unit with steam or oxygen reforming. The molar ratio of hydrogen to CO₂ may vary in wide proportions between 0.01 and 100. The process of the invention gives good results for a molar ratio of between 0.5 and 15 and is particularly well suited for ratios between 1 and 5.

A higher H₂/CO₂ molar ratio results in a better degree of conversion of CO₂ into CO but increases the size of the downstream unit needed to separate and recycle the excess H₂.

The process of the invention is preferably carried out continuously by making the gas mixture pass through at least one catalyst bed followed by an associated recovery of the water formed by condensation.

According to the invention, the operating pressure is between 10 and 40 bar, preferably between 15 and 25 bar, for example about 20 bar.

In practice, the operating pressure will be determined and optimized according to the devices and treatment units located downstream of the catalyst bed for the purpose of treating and purifying the gas mixture leaving the catalyst bed.

Moreover, a person skilled in the art will adapt the necessary amount of catalyst to the flow rate of the gas mixture entering the catalyst bed.

As an example, the volumetric hourly space velocity of the incoming gas mixture may be set between 3000 and 9000 Sm³/h per m³ of catalyst, preferably between 4000 and 7000 Sm³/h and better still between 4000 and 6000 Sm³/h.

Within the context of the invention, 1 Sm³ represents the volume of a cubic meter under standard temperature and pressure conditions.

The gas mixture leaving the catalyst bed contains steam, carbon monoxide and, as the reaction of H₂ with CO₂ is an equilibrium reaction, carbon dioxide and hydrogen that have not reacted.

The best conversion yields are obtained when the steam formed is removed from the reaction mixture progressively as it is formed.

This is because removal of the water allows the conversion equilibrium to be shifted toward CO formation:

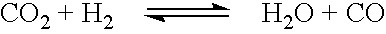

When the in situ removal of water requires the equipment to be operated cyclically, it is preferred to proceed in steps, by removing the water from the gas stream once the latter has left the catalyst bed.

After the water formed has been removed, the gas stream may be enriched with carbon monoxide by heating to a temperature of 300-520° C. and bringing it again into contact with the catalyst.

In fact, if after removing the water that it contains the gas mixture is again brought into contact with the catalyst at a suitable reaction temperature, a further portion of the carbon dioxide is converted into carbon monoxide, by bringing the reaction to a new state of equilibrium.

Thus, two preferred methods of implementing the process of the invention may be distinguished.

The first method (variant A) comprises the continuous implementation of the steps consisting in preparing a gas mixture rich in hydrogen and in carbon dioxide, having a temperature between 300 and 520° C., and then in making said gas mixture react, with the formation of carbon monoxide and water, by passing it through a catalyst bed furnished with a catalyst based on zinc oxide and chromium oxide, while separating the steam from the reaction mixture progressively as it is formed, so as to recover, downstream of said catalyst bed, a gas stream rich in carbon monoxide.

The second method (variant B) comprises the continuous implementation of the steps consisting in:

a)—preparing a gas mixture rich in hydrogen and in carbon dioxide, having a temperature of between 300 and 520° C., then

b)—in making said gas mixture react, with formation of carbon monoxide and steam, by passing said gas mixture through a catalyst bed furnished with a catalyst based on zinc oxide and chromium oxide and maintained at a pressure of 10 to 40 bar;

c)—cooling the gas stream leaving said catalyst bed so as to condense all or some of the steam formed;

d)—separating the condensed water from said gas stream; and

e)—if necessary, re-treating, at least once, the resulting gas stream raised beforehand to a temperature of 300 to 520° C., by implementing the preceding steps b) to d), so as to increase the proportion of carbon monoxide in the gas stream, each step b) being preferably carried out in a separate catalyst bed.

In step c), it is desirable to condense most of the water formed, preferably at least 80%, for example at least 90%, of the water formed.

In general, at this step the gas stream is cooled down to room temperature.

As a variant, it may be envisioned, in step c), to increase the proportion of condensed water by lowering the temperature using a refrigerating unit.

Step a) may be carried out either by mixing a gas stream rich in hydrogen with a gas stream rich in carbon dioxide, each gas stream being heated separately so as to have an appropriate temperature, or by heating a gas mixture rich in hydrogen and in carbon dioxide.

It is advantageous to heat the streams and gas mixtures to 300-520° C., in step a), and optionally to heat the gas stream to 300-520° C., in step e), by recovering the heat yielded during a subsequent cooling step and by means of an external heating means.

For example, the heat is recovered during the execution of step c) or of a subsequent step of type c).

Thus, according to one particularly preferred method of implementing the invention, the process comprises the steps consisting in:

a) preparing a gas mixture rich in hydrogen and in carbon dioxide, having a temperature of between 300 and 520° C., said temperature being reached by recovering the heat yielded during a subsequent step and by heat exchange with an external heat source;

b) making said gas mixture react, with formation of carbon monoxide and steam, by passing said gas mixture through a catalyst bed furnished with a catalyst based on zinc oxide and chromium oxide and maintained at a pressure of 10 to 40 bar;

c) cooling the gas stream leaving said catalyst bed down to room temperature by cutting off the heat, with step a) and by heat exchange with an external cold source, so as to condense all or some of the steam formed;

d) separating the condensed water from said gas stream; and

e) if necessary, re-treating, at least once, the resulting gas stream raised beforehand to a temperature of 300 to 520° C., by implementing the preceding steps b) to d), so as to increase the proportion of carbon monoxide in the outgoing gas stream, each step b) being preferably carried out in a separate catalyst bed.

Step e) is optional. It consists in re-treating, one or more times, and preferably 1 to 4 times, the outgoing gas stream by repeated implementation of a step of heating it to a temperature of 300 to 520° C. followed by steps b) to d).

According to a preferred method of implementation, the preheating to the temperature of 300 to 520° C. is carried out by recovering the heat yielded during the subsequent cooling step c) and by heat exchange with an external heat source.

At each additional re-treatment step (successive implementation of a step of heating to a temperature of 300 to 520° C. and then of steps b) to d)), the degree of conversion of CO₂ is increased and the flow rate of the gas stream to be heated, for the same CO production, is reduced. The desired degree of conversion depends on the intended use of the gas mixture obtained at the end of the process.

When the process of the invention is carried out continuously, each new step b) in the second method of implementation (variant B) is preferably carried out in a catalyst bed separate from the preceding one and therefore located downstream in the treatment line.

According to one particularly preferred method of implementing the invention, the process of the invention is carried out continuously by passing the gas mixture through at least two catalyst beds in series and by recovering the water generated by simply condensing it at room temperature.

Depending on the subsequent use envisioned, a person skilled in the art will achieve the best compromise between the degree of conversion, the number of equipment units to be used and their size, and the overall operating cost, and will consequently fix the optimum number of re-treatment steps.

Two types of operation are envisioned for the catalytic reactor:

a) a first, adiabatic, type of operation consists in heating the gas mixture to be made to react before it is introduced into the catalyst bed. Since the reaction of carbon dioxide with hydrogen is endothermic, the temperature of the gas stream leaving the catalyst bed is below that of the incoming gas mixture;

b) a second, nonadiabatic, type of operation consists in supplying the gas mixture with the heat needed to raise its temperature and to compensate for the heat consumed during the endothermic reaction, during its passage through the catalyst bed, by heating said catalyst bed by means of an external heat source. In this case, the temperature of the gas stream leaving said catalyst bed is higher than that previously and the degree of conversion of carbon dioxide is higher.

Whatever the way the process is carried out, the gas mixture produced comprises, in addition to carbon monoxide, hydrogen and carbon dioxide that have not reacted, and the steam formed.

According to one particularly advantageous method of implementation, the process of the invention comprises a subsequent step of treating the gas stream recovered at the end of the process, consisting in isolating the carbon dioxide produced or in isolating a carbon monoxide/hydrogen mixture, together with the steps for recycling the CO₂ and the excess hydrogen.

The invention will now be described with reference to the drawings and to the examples below. The drawings illustrate particular methods of implementing the process of the invention. It should be understood that the invention is not meant to be limited to these methods of implementation. A person skilled in the art may in particular envision the combination of the treatment and recycling techniques illustrated in two or more of these methods of implementation.

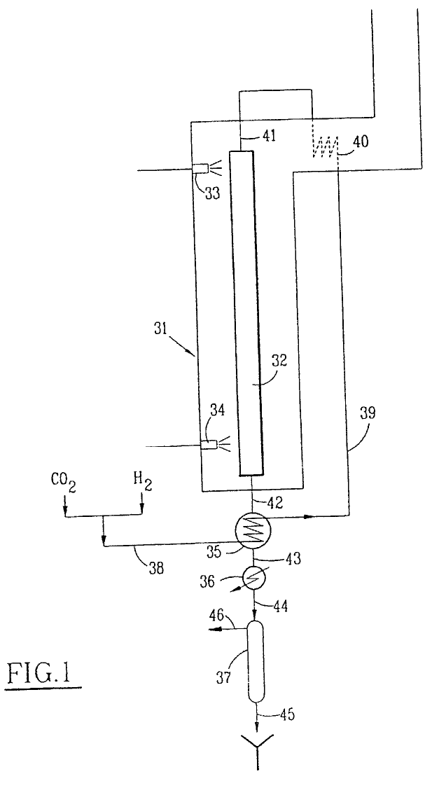

FIG. 1 shows schematically a single-stage plant for carrying out the process of the invention as described above, in which the catalyst bed operates nonadiabatically.

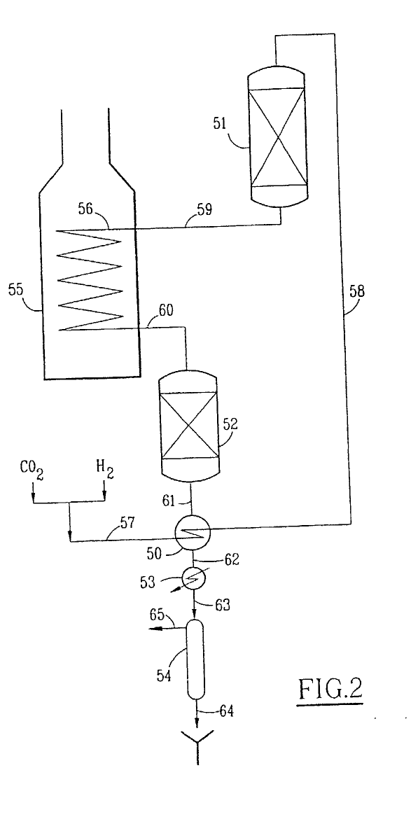

FIG. 2 shows schematically a two-stage plant for carrying out the process of the invention, which includes the intermediate heating of the gas stream leaving a first catalyst bed and the passage of said gas stream through a second catalyst bed, before removal of the water. In this method of implementation, the catalyst beds operate adiabatically.

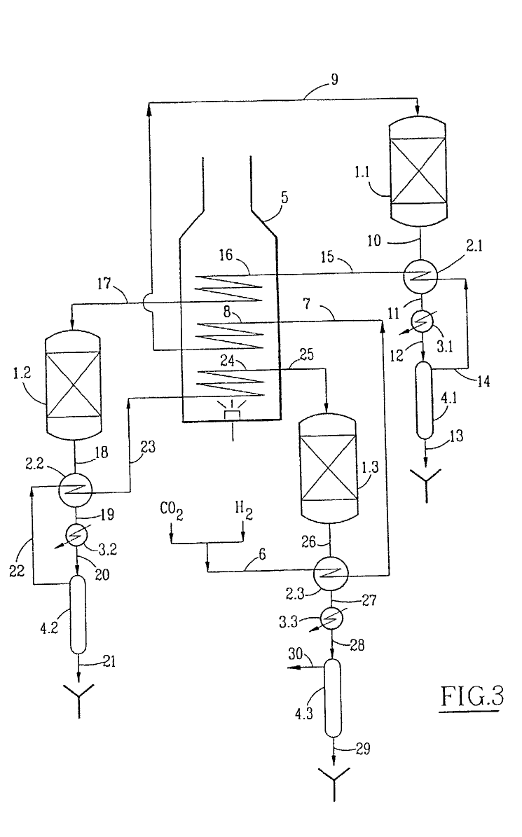

FIG. 3 shows schematically a three-stage plant for carrying out the process of the invention as described above, in which step e) comprises two re-treatment steps. In this plant, each catalyst bed operates adiabatically.

FIG. 4 shows a sectional view of a reactor for carrying out the process of the invention, in which the water is separated from the reaction mixture progressively as it is formed.

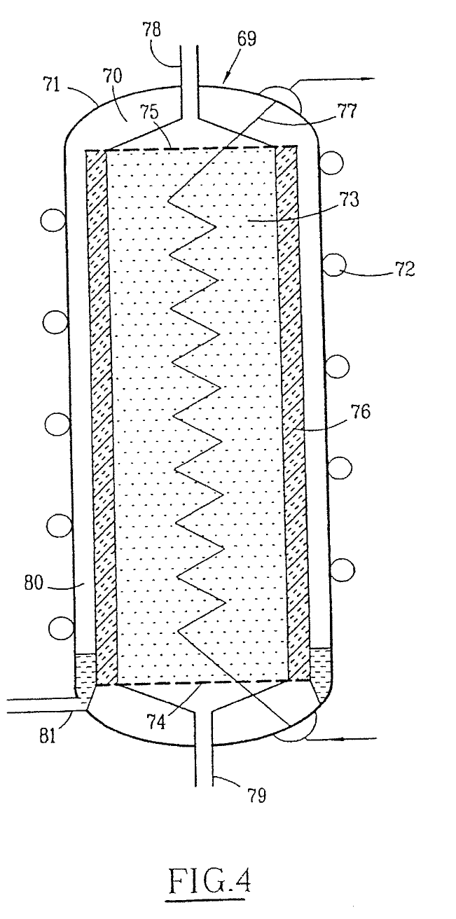

FIGS. 5 to 13 show flow diagrams illustrating preferred methods of implementing the invention for the process of separating carbon monoxide or carbon monoxide/hydrogen mixtures.

The plant in FIG. 1 comprises a furnace 31 in which is placed a heat exchanger, containing one or more catalyst beds 32 receiving heat by convection or radiation from the combustion effected in one or more burners 33 and 34, a heat exchanger 35, a condenser-cooler 36, a separator 37 and a heat recuperator 40 for recovering the heat from the combustion gases. During operation, the gas mixture comprising carbon dioxide and hydrogen is taken into the heat exchanger 35 via the line 38. On leaving the heat exchanger 35, the gas mixture is taken into a heat recuperator 40 via the line 39 where it is heated to a temperature of 422° C. The recuperator 40 runs into a line 41 feeding the catalyst bed 32. The catalyst bed 32 is heated continuously by the burners 33 and 34 and kept under a pressure of 25 bar. The temperature of the gas mixture leaving the catalyst bed 32 is 475° C. The gas mixture is taken into the heat exchanger 35 via the line 42, where it is cooled, and then flows in the line 43 to the condenser-cooler 36, from where it is taken into the separator 37 via the line 44. The condensed water is removed via the line 45 and the gas mixture is recovered via the line 46.

The compositions of the gas mixtures at certain points in the plant are given in table 1 below, in molar percentages.

TABLE 1

| Constituents | | | |
|---|---|---|---|
| of the | | | |
| mixture | “38” | “42” | “46” |
| CO | | 13.38 | 15.39 |
| CO₂ | 33.33 | 19.95 | 22.95 |
| H₂ | 66.67 | 53.29 | 61.32 |
| H₂O | | 13.38 | 0.34 |

The plant in FIG. 2 comprises two reactors 51 and 52 furnished respectively with catalyst beds, a preheat furnace 55, a heat exchanger 50, a condenser-cooler 53 and a separator 54.

A line 57 takes the gas mixture into the heat exchanger 50 where it is heated up to 422° C. This gas mixture flows via the line 58 into the reactor 51 and is allowed to pass through the catalyst bed (not shown) with which the reactor 51 is furnished, from where it emerges at a temperature of 355° C. During this operation, the catalyst bed is maintained at a pressure of 25 bar. The line 59 transfers the gas mixture between the reactor 51 and the preheater 56 placed in the preheat furnace 55. The preheater runs into the line 60, which is connected to the reactor 52. The reactor 52 is maintained at a pressure of 25 bar. The temperature of the gas mixture flowing in the line 60 is 523° C. After having passed through the catalyst bed of the reactor 52, the gas mixture, whose temperature has dropped to 475° C, is taken via the line 61 into the heat exchanger 50. On leaving the heat exchanger 50, where it is cooled, the gas mixture is taken into the cooler 53 and then into the separator 54, via the lines 62 and 63. The condensed water is removed from the separator 54 via the line 64 and the residual gas is available at a temperature of 35° C in the line 65.

The composition of the gas mixtures at certain points in the plant is given in table 2 below, in molar percentages:

TABLE 2

| Constituents | | | | |
|---|---|---|---|---|
| of the | | | | |
| mixture | “57” | “59” | “61” | “65” |
| CO | | 8.64 | 13.38 | 15.39 |
| CO₂ | 33.33 | 24.69 | 19.95 | 22.95 |
| H₂ | 66.67 | 53.03 | 53.29 | 61.32 |
| H₂O | | 8.64 | 13.38 | 0.34 |

FIG. 3 shows a preferred embodiment of the invention. It essentially comprises three adiabatic reactors 1.1, 1.2 and 1.3, three heat exchangers 2.1, 2.2 and 2.3, three condenser-coolers 3.1, 3.2 and 3.3, three separators 4.1, 4.2 and 4.3 and three preheaters 8, 16 and 24 placed in a preheat furnace 5 provided with one or more burners.

The reactors 1.1, 1.2 and 1.3 are furnished with a catalyst bed (not shown) consisting of a catalyst based on ZnO and Cr_{2O}₃ containing no iron.

Each of the reactors 1.1, 1.2 and 1.3 operate at a pressure of about 25 bar.

The starting gas mixture, composed of hydrogen and carbon dioxide, feeds the heat exchanger 2.3 via the line 6 where it is preheated to 420° C. and then sent into the preheater 8 placed in the preheat furnace 5 via the line 7. Prehated to 515° C., it then feeds the reactor 1.1 via the line 9. After passing over the catalyst of the reactor, the outgoing mixture is at a temperature of 435° C. It enters the exchanger 2.1 via the line 10, yields up some of its heat in said exchanger, and then, via the line 11, it enters the condenser-cooler 3.1 and is cooled therein.

The two-phase mixture output by the condenser-cooler 3.1 at about 35° C. is taken into the separator 4.1 via the line 12. The condensed water is removed from the separator 4.1 via the line 13, while the gas phase is available for a new treatment step in the line 14.

The available gas mixture output by the separator 4.1, composed of H₂, CO₂, CO and H₂O, feeds the heat exchanger 2.1 via the line 14 where it is preheated to 390° C., and is then sent via the line 15 into the preheater 16 placed in the preheating furnace 5. Preheated to 520° C., it then feeds the reactor 1.2 via the line 17. After passing over the catalyst of the reactor, the outgoing mixture is at a temperature of 460° C. Via the line 18 it enters the heat exchanger 2.2, and yields up some of its heat therein, and then, via the line 19, it enters the condenser-cooler 3.2 and is cooled therein.

The two-phase mixture output by the condenser-cooler 3.2, at about 35° C., is taken into the separator 4.2 via the line 20. The condensed water is removed from the separator 4.2 via the line 21, while the gas phase is available for a new treatment step in the line 22.

The available gas mixture output by the separator 4.2, composed of H₂, CO₂, CO and H₂O, feeds the heat exchanger 2.2 via the line 22 where it is preheated to 410° C., and is then sent via the line 23 into the preheater 24 placed in the preheat furnace 5. Preheated to 510° C., it then feeds the reactor 1.3 via the line 25. After passing over the catalyst of the reactor, the outgoing mixture is at a temperature of 465° C. Via the line 26 it enters the heat exchanger 2.3, and yields up part of its heat therein, and then, via the line 27, it enters the condenser-cooler 3.3 and is cooled therein.

The two-phase mixture output by the condenser-cooler 3.3, at about 35° C., is taken into the separator 4.3 via the line 28. The condensed water is removed from the separator 4.3 via the line 29, while the gas phase is available in the line 30 for feeding a downstream unit for CO purification and H₂/CO₂ recycling.

The plant in FIG. 3 is optimized insofar as each of the heat exchangers 2.1, 2.2 and 2.3 uses the thermal energy, dissipated while the gas streams leaving the reactors 1.1, 1.2 and 1.3 are being cooled, to heat the gas streams recovered at the outlets of the condensers 4.1, 4.2 and 4.3.

The compositions of the gas mixtures at the various points in the plant are given in table 3 below, in molar percentages.

TABLE 3

| Constituents | | | | | |
|---|---|---|---|---|---|
| of the | | | | | |
| mixture | “6” | “10” | “18” | “26” | “30” |
| CO | | 10.71 | 18.81 | 24.96 | 26.22 |
| CO₂ | 33.33 | 22.62 | 18.40 | 14.99 | 15.74 |
| H₂ | 66.67 | 55.96 | 55.60 | 54.94 | 57.70 |
| H₂O | | 10.71 | 7.19 | 5.11 | 0.34 |

FIG. 4 is a schematic sectional view of a reactor 69 for implementing the process according to the invention, in which the steps consisting in treating the gas mixture at a temperature of 300-520° C. in the presence of the ZnO—Cr_{2O}₃ catalyst and in removing the water formed, are carried out concomitantly. The reactor 69 consists of a closed vessel 70 of vertical axis, closed by an outer shell 71 fitted, along the entire length of the vessel, with a cooling means 72 in which a cooling liquid circulates. Placed inside the closed vessel 70 is a catalyst bed 73 furnished with a catalyst based on ZnO and Cr_{2O}₃ and not containing iron. The catalyst bed 73, of cylindrical shape, is placed within the reactor 69, along its vertical axis, and is isolated from the rest of the vessel by grids 74 and 75 at the top and bottom of it and by a layer of thermally insulating material 76, which is permeable to steam, over its entire lateral surface.

A heat exchanger 77, which is positioned along the axis of the reactor, within the catalyst bed, and in which a heat-transfer fluid circulates, delivers the heat needed to compensate for the heat losses around the vessel 71 and the heat necessary for the endothermic reaction.

Said heat exchanger 77, which is placed along the vertical axis of the reactor 69 and in which a heating liquid circulates, passes right through the catalyst bed 73. More specifically, the heating coil 77 passes through the upper end of the jacket 71, then the grid 75, and emerges in the catalyst bed 73, through which it passes. The heating coil 77 passes through the grid 74 at the bottom end of the catalyst bed and then the bottom end of the jacket 71.

The reactor 69 furthermore includes a gas feedstock pipe 78, which passes through the top end of the jacket 71, along the central axis of the catalyst bed. The side walls of the pipe 78 flair out in the form of a cone above the grid 75 so as to distribute the gas feedstock over the entire cross section of the catalyst bed. Likewise, the reactor includes a pipe 79 for discharging the gas mixture created just below the grid 74, located at the bottom end of the catalyst bed, passing through the jacket 71 at its bottom end, the shape of the pipe 79 being exactly symmetrical with that of the pipe 78.

The insulating material 76 and the jacket 71 define an annular space 80 intended for recovering the water formed. At the bottom end of the annular space 80, a pipe 81 for removing the water passes through the jacket 71.

During production, the reactor 69 is fed continuously with the gas mixture based on hydrogen and carbon dioxide via the pipe 78. The gas mixture flows through the catalyst bed 73, where it is made to react, the catalyst bed being permanently maintained at a temperature of 300-520° C. by means of the heat exchanger 77, and at a pressure of 10 to 40 bar.

The steam formed closed to the lateral surface of the catalyst bed passes through the insulating material 76 and condenses on the internal surface of the jacket 71. A partial steam pressure gradient appears in the radial direction perpendicular to the vertical axis of the catalyst bed. Owing to the effect of this partial pressure gradient, the steam formed within the catalyst bed migrates into the annular space 80 where it is condensed. The water formed is thus removed progressively as it is formed.

Thus, the gas recovered via the pipe 79 is practically free of the steam formed during the reaction.

To produce this particular embodiment, a person skilled in the art will be able to develop a specific, steam-permeable, thermally insulating material, or use suitable materials available in the art.

FIG. 5 shows the block diagram of a unit for producing carbon monoxide and possibly H₂, which includes a module 82 generating a mixture of H₂, CO and CO₂, a module 83 using the process of the invention to increase the amount of CO produced, and a module 84 using a PSA process to separate an H₂-rich stream a), a CO₂-rich stream b) and a CO-rich stream c). More specifically, the module 82 is a device for the steam, oxygen or CO₂ reforming of hydrocarbons, and the module 83 is operated at a pressure between 10 and 40 bar.

The H₂-rich stream is partly recycled by means of the compressor 85 into the module 83, the excess being discharged from the unit 86. A variant consists in discharging all the hydrogen coming from the module 84.

The CO₂-rich stream, also containing H₂ and CO, is used as heating gas in the unit 82. A variant consists in using it as heating gas in the unit 83.

The CO-rich stream is discharged from the unit 86.

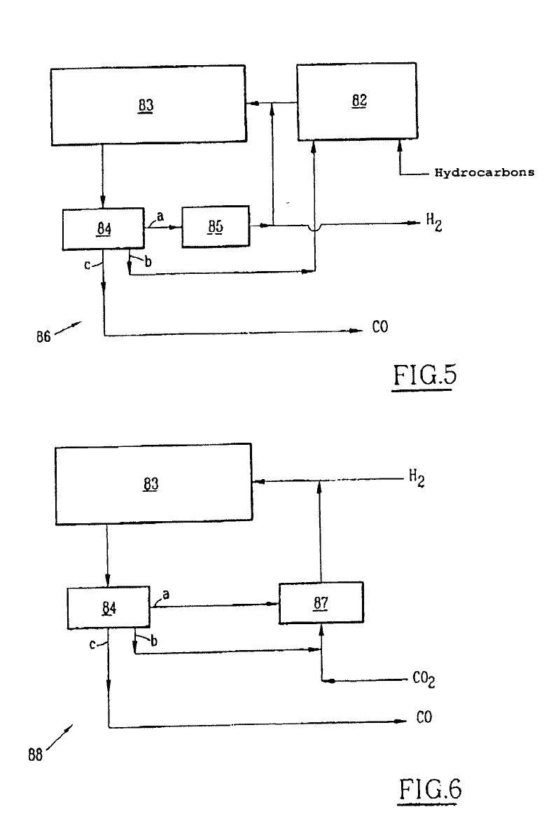

FIG. 6 describes a unit 88 which includes a CO production module 83, a PSA module 84 and a CO₂ compressor 87.

This unit 88 is very similar to the previous one, but it is installed on a site where CO₂ is available at low pressure, for example close to an ammonia synthesis unit, and is fed with H₂ by an independent unit, in particular via a pipeline.

The unit 83 is fed with H₂ directly from the pipeline and with CO₂ via the compressor 87.

The streams a) and b) are recycled into the inlet of the module 83 via the compressor 87, making best use of the available compression stages.

A variant consists in using all or some of the stream b) as heating gas for the module 83.

The block diagram of FIG. 7 illustrates a production unit 90 comprising a CO production module 83, a selective-membrane permeation module 89, a PSA module 84 and a CO₂ compressor 87.

The gas mixture output by the module 83 is firstly treated in the module 89, which includes selective membranes to recover most of the H₂ from the permeate b). The waste from the membrane is then treated in the PSA unit 84 with production of a CO-rich stream c).

The stream a) output by the module 89 and the CO₂-rich stream d) output by the module 84 are recycled via the compressor 87 with the CO₂ feeding the unit.

A variant consists in using all or part of the stream d) as heating gas for the module 83.

The block diagram in FIG. 8 describes a unit 93 for producing CO and an H₂/CO mixture, comprising the CO production module 83, a permeation module 89, a compressor 87, a liquid-phase CO₂ absorption module 91 and a cryogenic drying and separating module 92. As in the previous diagram, part of the hydrogen output by the module 83 is separated by selected permeation in the module 89. The waste from the membranes module b) is then treated in the module 91 where the CO₂ is removed by liquid-phase absorption. The decarbonated gas c) is therefore a mixture comprising essentially H₂ and CO, with an H₂/CO ratio defined for the requirements of the industry and controlled by the module 89. One part (or all) of this mixture then constitutes a production of the unit 93; the other part is treated in the module 92 in order to produce a CO-rich fraction d).

The permeate output by the module 89, the CO₂-rich stream f) output by the module 91, after regeneration of the solvent, and the waste rich in CO and H₂ e) output by the module 92 are recycled into the module 83 via the compressor 87, with the feed CO₂.

A variant consists in using all or part of the stream e) as heating gas for the module 83.

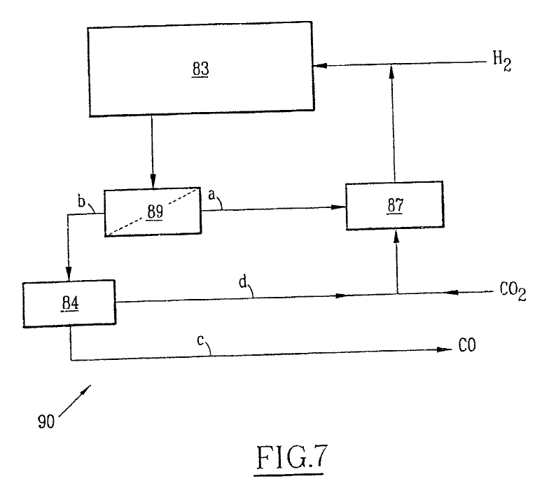

FIG. 9 illustrates the block diagram of a CO production unit 94 comprising a production module 83, a liquid-phase CO₂ absorption module 91 and a cryogenic drying and separating module 92. All of the mixture output by the module 83 is treated in the module 91 and the decarbonated gas a) is treated in the module 92 which produces a deliverable CO-rich fraction e) discharged from the unit.

The CO₂-rich gas output by the module 91, the H₂-rich gas c) and the waste gas rich in H₂ and CO d) output by the module 92 are recycled into the module 83 via the compressor 87 with the feed CO₂.

As a variant, all or part of the stream d) may be used as heating gas for the unit 83.

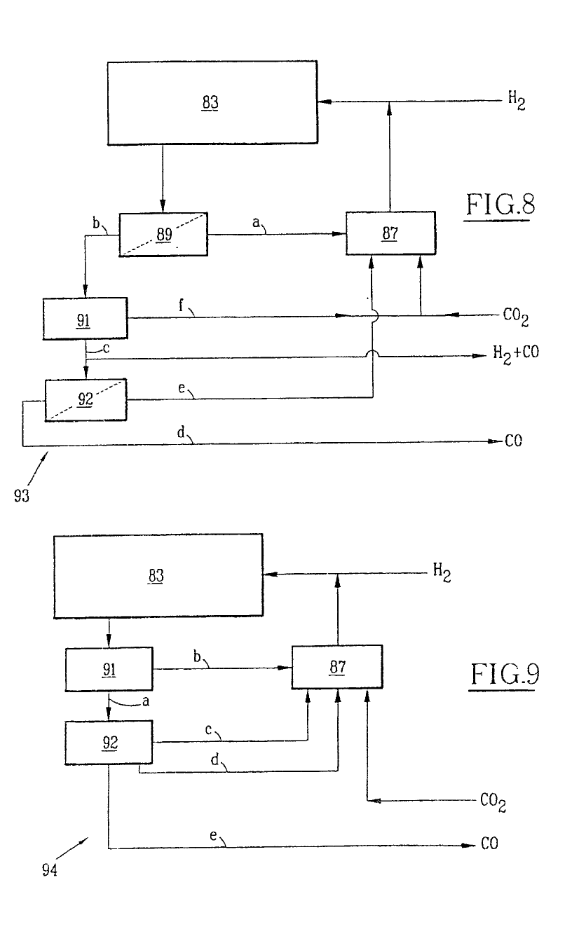

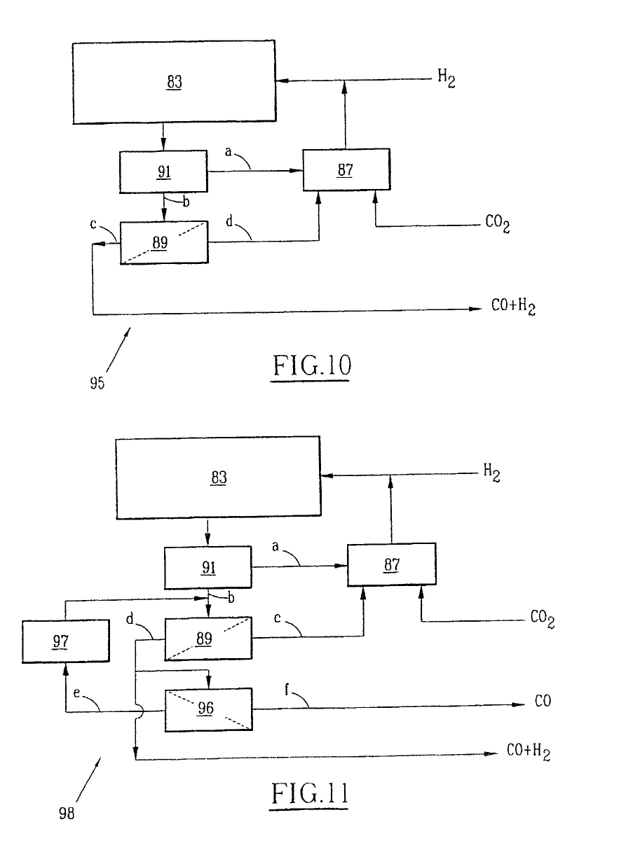

FIG. 10 illustrates the block diagram of a unit 95 for producing an H₂/CO mixture, comprising the CO production module 83, the liquid-phase CO₂ absorption module 91, the compressor 87 and the permeation module 89.

The mixture output by the module 83 is treated in the module 91 and the decarbonated gas b) is treated in the module 89 which produces a mixture comprising essentially H₂ and CO with an industry-specified ratio.

The CO₂-rich stream a) output by the module 91 and the H₂-rich stream d) output by the module 89 are recycled into the module 83 via the feed CO₂ compressor 87.

FIG. 11 describes a unit 98 for producing CO and an H₂/CO mixture, comprising a CO production module 83, a CO₂ liquid-phase absorption module 91, a compressor 87, two permeation modules 89 and 96 and a compressor 97.

As in the previous diagram, the modules 83, 91, 89 and 87 make it possible to produce an H₂/CO mixture with an H₂/CO ratio corresponding to the requirements of the industry, but in addition part of this mixture is treated in the additional permeation module 96 in order to produce a CO-rich fraction f). The permeate e) from this membrane is an H₂/CO mixture which is recycled into the inlet of the module 89 via the compressor 97.

The following example illustrates the invention further.

### ILLUSTRATIVE EXAMPLE

A test was carried out for about 1200 hours with a catalyst containing:

| | |
|---|---|
| ZnO | 77.5% by weight |
| Cr₂O₃ | 21.3% by weight |
| NiO | 1.2% by weight |

The catalyst bed was fed with a gas mixture, the composition of which was the following:

| | |
|---|---|
| H₂ | 74.2% by volume |
| CO₂ | 24.7% by volume |
| CO | 1.0% by volume |
| H₂O | 0.1% by volume |

The catalyst bed was operated at 20 bar with a mean temperature of 430° C.

The composition of the gas output by the reactor was the following:

| | |
|---|---|
| H₂ | 71.3% by volume |
| CO₂ | 15.8% by volume |
| CO | 12.1% by volume |
| CH₄ | 0.8% by volume |

The degree of CO₂ conversion was then 40%.

1. A process for the production of carbon monoxide by reverse conversion, in the gas phase, of gaseous carbon dioxide and gaseous hydrogen, while minimizing the production of methane, characterized in that the reaction is carried out at a temperature of 300 to 520° C. and at a pressure of 10 to 40 bar in the presence of a catalyst based on zinc oxide and chromium oxide and not containing iron.

2. The process as claimed in claim 1, characterized in that said catalyst includes no more than 2.5% by weight of nickel.

3. The process as claimed in either of the preceding claims, characterized in that the weight ratio of zinc oxide to chromium oxide is between 1.5 and 4.5, preferably between 1.5 and 2.5.

4. The process as claimed in any one of the preceding claims, characterized in that it is carried out continuously and in that it comprises the step consisting in making a gas mixture rich in hydrogen and carbon dioxide pass at a temperature of 300 to 520° C. through a catalyst bed furnished with said catalyst.

5. The process as claimed in claims 4, characterized in that the molar ratio of hydrogen to carbon dioxide in said gas mixture is between 0.5 and 15.

6. The process as claimed in any one of the preceding claims, characterized in that the reaction is carried out at a pressure of 15 to 25 bar.

7. The process as claimed in claim 4, characterized in that the volumetric hourly space velocity of the gas mixture entering said catalyst bed is between 4000 and 6000 Sm³/h per m³ of catalyst present in the catalyst bed.

8. The process as claimed in any one of the preceding claims, characterized in that it furthermore includes the step consisting in separating the steam contained in the gas mixture, produced during the reaction, by condensation.

9. The process a claimed in any one of the preceding claims, characterized in that the steam formed is separated from the mixture progressively as it is formed.

10. The process as in any one of claims 1 to 7, characterized in that it is carried out continuously and in that it comprises the steps consisting in:
a) preparing a gas mixture rich in hydrogen and in carbon dioxide, having a temperature of between 300 and 520° C.;
b) in making sail gas mixture react, with formation of carbon monoxide and steam, by passing said gas mixture through a catalyst bed furnished with a catalyst based on zinc oxide and chromium oxide and maintained at a pressure of 10 to 40 bar;
c) cooling the gas stream leaving said catalyst bed so as to condense the steam formed;
d) separating the condensed water from said gas stream; and
e) if necessary, re-treating, at least once, the resulting gas stream raised beforehand to a temperature of 300 to 520° C., by implementing the preceding steps b) to d), so as to increase the proportion of carbon monoxide in the gas stream.

11. The process as claimed in claim 10, characterized in that, in step e), the gas stream is re-treated from one to four times.

12. The process as claimed in either of claims 10 and 11, characterized in that it comprises the steps consisting in:
a) preparing a gas mixture rich in hydrogen and in carbon dioxide, having a temperature of between 300 and 520° C., said temperature being reached by recovering the heat yielded during a subsequent step and by heat exchange with an external heat source;
b) making said gas mixture react, with formation of carbon monoxide and steam, by passing said gas mixture through a catalyst bed furnished with a catalyst based on zinc oxide and chromium oxide and maintained at a pressure of 10 to 40 bar;
c) cooling the as stream leaving said catalyst bed down to room temperature by cutting off the heat, with step a) and by heat exchange with an external cold source, so as to con dense all or some of the steam formed;
d) separating the condensed water from said gas stream; and
e) if necessary, retreating, at least once, the resulting gas stream raised beforehand to a temperature of 300 to 520° C., by implementing the preceding steps b) to d), so as to increase the proportion of carbon monoxide in the outgoing gals stream, each step b) being preferably carried out in a separate catalyst bed.

13. The process as claimed in any one of claims 4 to 12, characterized in that the catalyst bed is heated by an external heat source in such a way that the temperature of the outgoing gas stream is not less than the temperature of the incoming gas mixture.

14. The process as claimed in and any one of claims 10 to 12, characterized in that, before the steam is separated, the outgoing gas stream reheated beforehand to a temperature between 300 and 500° C., is made to pass again through a second catalyst bed furnished with said catalyst.

15. A reactor (69) for implementing the process as claimed in claim 9, consisting of a closed vessel (70) of vertical axis closed by an external shell (71) and comprising:
(i) a cylindrical reaction chamber (73) furnished with a catalyst based on zinc oxide and chromium oxide and not containing iron, placed within said reactor along its vertical axis and bounded over its entire lateral surface by a layer (76) of thermally insulating steam-permeable material and at its two ends, top and bottom, by two grids (74, 75), a free annular space (80) being provided between the external shell (71) and said layer (76) of thermally insulating material;
(ii) a cooling means (72) wound around the external shell (71) of the reactor;
(iii) a heat exchanger (77) placed along the vertical axis of the reactor within the reaction chamber (73) and passing right through the reactor (69);
(iv) a gas feedstock pipe (78);
(v) a pipe (79) for discharging the outgoing gas stream; and
(vi) a water discharge pipe (81).

16. The process as claimed in any one of claims 1 to 14, characterized in that the gas mixture, the product of the reaction, which comprises carbon monoxide, carbon dioxide and hydrogen, is treated so as to isolate the carbon monoxide or a carbon monoxide/hydrogen mixture.
